(19) United States
(12) Patent Application Publication
(10) Pub. No.: US 2014/0225860 A1
(43) Pub. Date: Aug. 14, 2014

(54) DISPLAY APPARATUS

(71) Applicant: FUJITSU TEN LIMITED, Kobe-shi (JP)

(72) Inventors: Tetsuaki AONO, Kobe-shi (JP); Takashi OHTA, Kobe-shi (JP); Takaho OKADA, Kobe-shi (JP); Yuu NISHIO, Kobe-shi (JP)

(73) Assignee: FUJITSU TEN LIMITED, Kobe-shi (JP)

(21) Appl. No.: 14/022,811

(22) Filed: Sep. 10, 2013

(30) Foreign Application Priority Data
Feb. 12, 2013 (JP) 2013-024255

(51) Int. Cl. G06F 3/044

(52) U.S. Cl. CPC G06F 3/044
USPC 345/174

(57) ABSTRACT

A display apparatus that displays an image detects user proximity to a display surface of a display; and causes a light source to emit light in different states, depending on whether the user proximity is proximity with one point or with plural points. Thus, the user can understand whether or not the display apparatus is ready to receive a close range operation to execute a user objective function.

### BACKGROUND OF THE INVENTION

1. Field of the Invention

The invention relates to a display apparatus that displays images.

2. Description of the Background Art

Recently, there are technologies that execute a function of a display apparatus by performing a contactless operation with a finger, a palm, etc. of a user in proximity to a display of the display apparatus. A self capacitive method and an infrared method are among examples of the technologies used for such a contactless operation. The self capacitive method detects proximity of the finger, the palm, etc. based on a change in capacitance. Moreover, in addition to the self capacitive method and the infrared method, there is a technology for performing a contactless operation by detecting a position, a moving direction, and a moving speed, etc. of the palm of the user in proximity to the display of the display apparatus, based on a captured image of the palm captured by a camera provided to the display apparatus.

A sensor that detects proximity of the user to the display is included in the display apparatus that has a configuration to execute a function in accordance with a contactless operation performed by the user. Therefore, in order to execute a function of the display apparatus by the contactless operation, the user has to operate the display apparatus in a range in which the sensor can detect the operation. However, the user cannot see the range in which the sensor can detect the operation. Therefore, even if the user moves closer to the display to execute the function of the display apparatus, there are cases where the function of the display apparatus is not executed because the user is located outside the range in which the sensor can detect the operation.

### SUMMARY OF THE INVENTION

According to one aspect of the invention, a display apparatus includes a detector that detects (i) proximity of an object to the display and (ii) an operation that is performed by the object after detecting the proximity. The display apparatus further includes a controller that discriminates between at least two types of the proximity of the object before the operation performed by the object after detecting the proximity, and that controls an informing part to provide different information, depending on a discriminated result.

The detector detects the proximity of the object and the controller discriminates between two types of the proximity and provides the different information. Therefore, a user can understand the type of the proximity of the object. Thus, a user can understand that the operation that is performed after detecting the proximity is ready to be received.

According to another aspect of the invention, a display apparatus includes: a detector that detects user proximity to one or both of the display surface and an operation portion area provided near the display surface; a light source; and a controller that causes the light source to emit light in different states, depending on whether the user proximity is proximity with one point or with plural points to the display surface.

The detector detects user proximity and the controller causes the light source to emit light in different states, depending on whether the user proximity is proximity with one point or with plural points. Therefore, a user can understand that the user proximity is recognized as the proximity with the one point or as the proximity with the plural points.

Therefore, an objective of the invention is to provide a technology that allows a user to understand whether or not a display apparatus is ready to receive an operation performed by the user.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an external appearance of a display apparatus;

FIG. 2 is a block diagram illustrating a configuration of a display apparatus;

FIG. 3 is a flowchart illustrating a process performed by a display apparatus in response to an operation performed by a user;

FIG. 4 illustrates an example of plural-point proximity of a user to an operation surface of a touch panel;

FIG. 5A and FIG. 5B are sectional views showing a section along line A-A′ of a display apparatus;

FIG. 6 illustrates an example of one-point proximity to an operation portion;

FIG. 7A and FIG. 7B are sectional views showing a section along line B-B′ of a display apparatus;

FIG. 8 illustrates a state where light sources provided to an operation portion area are emitting light;

FIG. 9 illustrates a state where light sources provided to an operation portion area are emitting light;

FIG. 10A and FIG. 10B illustrate reception of a gesture operation with plural points of a user; and

FIG. 11A and FIG. 11B illustrate reception of a gesture operation with one point of a user.

### DESCRIPTION OF THE EMBODIMENTS

Embodiments of the invention are hereinafter explained with reference to the drawings.

### 1. First Embodiment

<1-1. Outline>

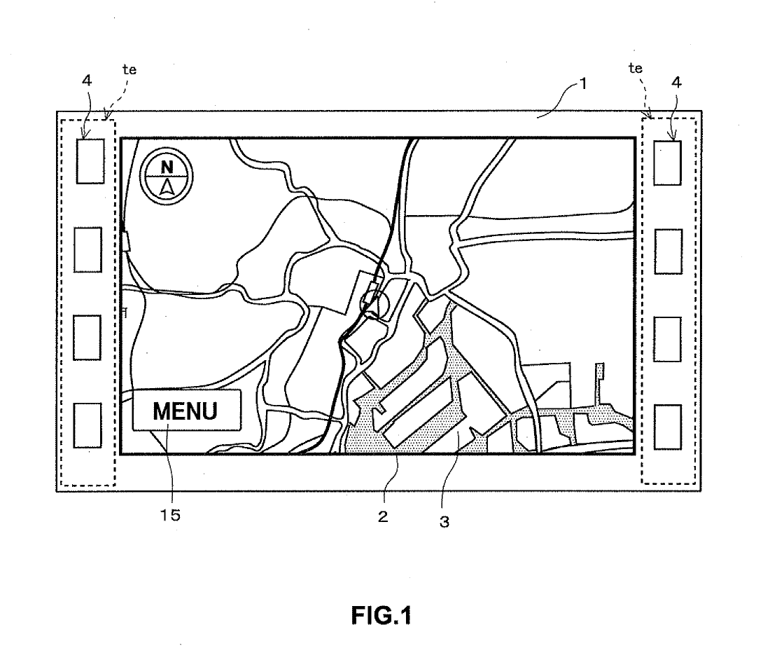

An outline of a display apparatus of the invention is explained. FIG. 1 illustrates an external appearance of a display apparatus 1 in this embodiment. The display apparatus 1 is used, for example, in a vehicle such as a car. The display apparatus 1 executes a function of the display apparatus 1 and then displays different information to a user such as a driver in a cabin of the vehicle. Examples of the functions of the display apparatus 1 are a navigation function that shows a map image to show a route to a destination and an audio function that outputs sound in the cabin. Moreover, the display apparatus 1 also functions as a character entry apparatus. For example, when setting a destination in the navigation function, or when changing a title of audio data in the audio function, the user can enter a character, using the display apparatus 1.

Moreover, the display apparatus 1 includes a touch panel. Each functions of the display apparatus 1 is executed by an operation performed by the user with touch panel. The touch panel can be operated with or without contact. Capacitance of an operation surface of the touch panel is changed when the user operates the touch panel. A position of the touch panel to which the user has operated is obtained based on the changed capacitance. Moreover, an amount of the changed capacitance partially depends on number of fingers used to operate the touch panel by the user. Therefore, it is possible to determine that one finger or more than one finger is used to operate the touch panel by the user, based on the amount of the changed capacitance.

The display apparatus 1 in this embodiment includes a light source that can emit light in a plurality of colors. When at least one finger is located by the user at a position from which the touch panel can be operated by the finger, the light source emits light having a color corresponding to number of the fingers. In other words, the display apparatus 1 detects the finger located by the user at the position from which the touch panel can be operated by the finger and determines number of the fingers, and then emits light having the color corresponding to the number of the fingers. As mentioned above, even in a case where the user operates the display apparatus 1 of the invention without contact, the display apparatus 1 enables the user to understand whether or not the finger is located by the user at the position that the touch panel reacts to the finger. Moreover, for example, in a case where the functions of the display apparatus I are set to be executed depending on the numbers of the fingers, the user can understand a function that can be executed, by seeing the color of the emitted light.

<1-2. Configuration>

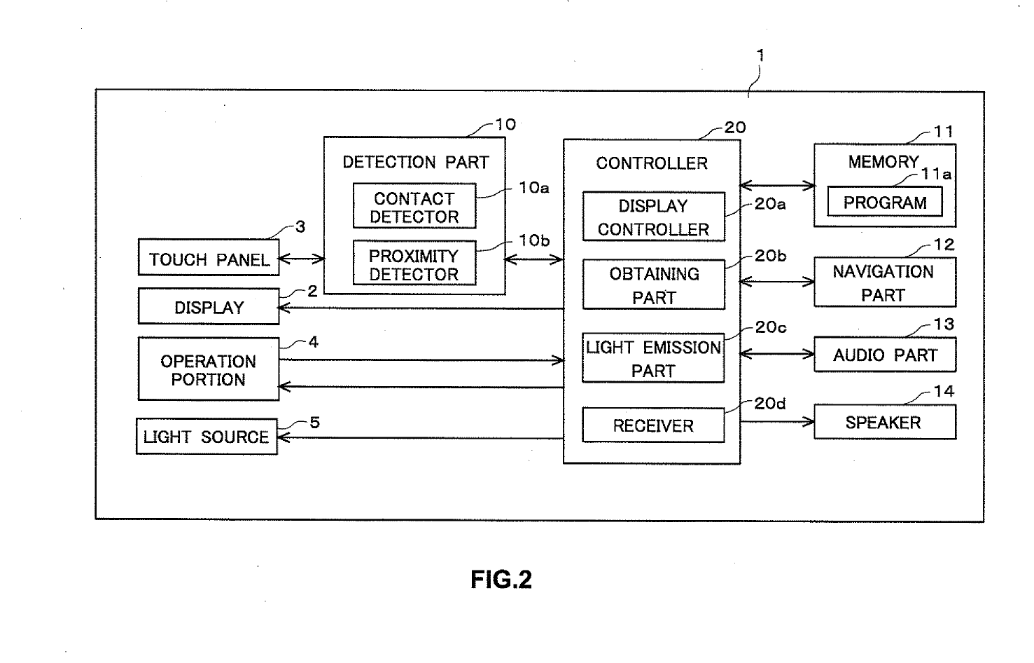

Next explained is a configuration of the display apparatus 1. FIG. 2 is a block diagram illustrating an outline configuration of the display apparatus 1. As shown in FIG. 2, the display apparatus 1 includes a display 2, a touch panel 3, an operation portion 4, a light source 5, a detection part 10, a memory 11, a navigation part 12, an audio part 13, a speaker 14, and a controller 20.

The display 2 includes, for example, a glass substrate and displays different information. The touch panel 3 is a panel with which the user operates the display apparatus 1 with or without contact. Electrodes such as transparent electrodes, not illustrated, are provided to the operation surface of the touch panel 3. Moreover, the electrodes of the touch panel 3 are connected to a sensor that detects the changed capacitance at the individual electrodes.

The operation surface of the touch panel 3 is provided to overlay a display surface of the display 2. Moreover, positions on the operation surface of the touch panel 3 correspond to positions on the display surface of the display 2. The operation surface of the touch panel 3 is provided closer to the user than the display surface of the display 2. A protection sheet or the like is provided on a surface of the touch panel 3.

For example, a command button and the like are displayed on the display surface of the display 2. When the user performs a user operation with the finger by touching a position on the operation surface of the touch panel 3 corresponding to an area in which the command button is displayed, the display apparatus 1 receives a command associated with a position of the command button. Once receiving the command, the display apparatus 1 performs a process corresponding to the command. Thus, a user objective function is executed.

The user operation performed with at least one finger by touching the operation surface of the touch panel 3 is hereinafter referred to as a contact operation. The display apparatus 1 detects a touched position based on an amount of the changed capacitance caused on the operation surface of the touch panel 3 by the contact operation, and receives a command associated with the position.

Moreover, there is a close range operation different from the contact operation mentioned above. The close range operation is a user operation performed with at least one finger located in proximity to the operation surface of the touch panel 3. When the user locates the finger in proximity to the operation surface of the touch panel 3, even without contact, the capacitance of the operation surface is changed. Based on the amount of the changed capacitance, the display apparatus 1 detects that at least one finger is located in proximity by the user (hereinafter referred to as user proximity) and also detects a proximity position of the detected finger located in proximity. Hereinafter, “the operation surface of the touch panel 3” may be referred to simply as “the touch panel 3.”

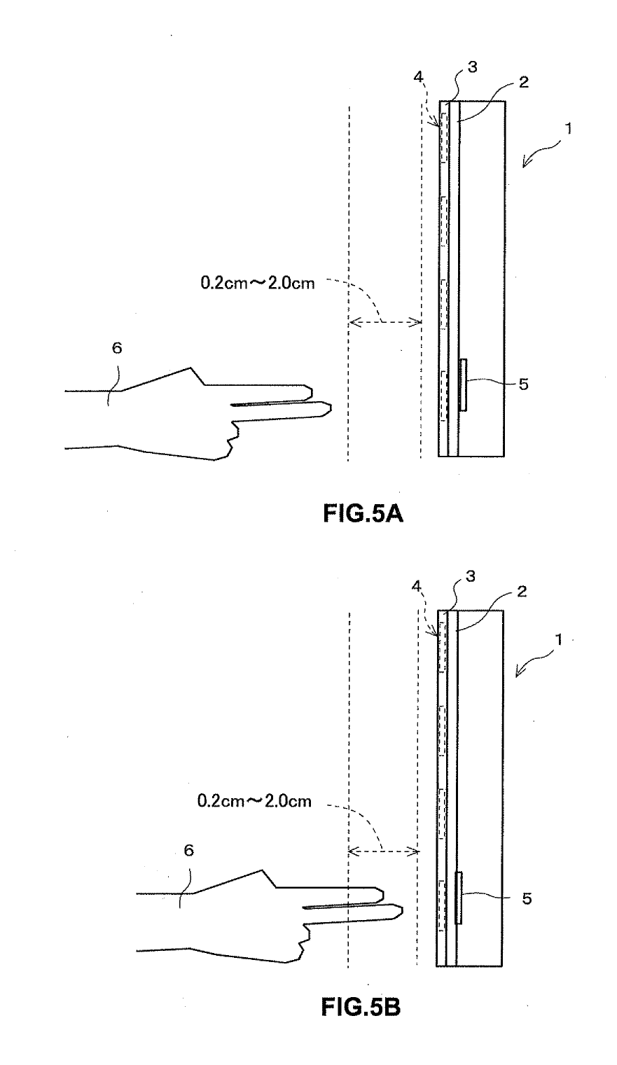

When detecting the proximity position, the display apparatus 1 receives a command associated with the proximity position. Once receiving the command, the display apparatus 1 performs a process corresponding to the command. In other words, a user objective function is executed. A proximity state is a state where the user locates at least one finger in proximity to the operation surface of the touch panel 3, for example, where a finger tip of the user is located in a range of 0.2 cm to 2.0 cm away from the operation surface, as shown in FIG. 5B later described.

The operation portion 4 is a physical switch used to operate the display apparatus 1 by the user. The operation portion 4 is, for example, a hard button. The plural operation portions 4 are provided near the display 2. When the user touches and presses one of the plural operation portions 4 with the finger, the display apparatus 1 receives a command associated with the operation portion 4 (hard button) touched by the user.

Moreover, electrodes, such as transparent electrodes, are provided to the operation portions 4 and a near area of the operation portions 4 (hereinafter referred to as “operation portion area”). Therefore, when the user locates the finger in proximity to the operation portion area, an amount of capacitance is changed. Thus, the display apparatus 1 detects the user proximity to the operation portion area and also detects the proximity position of the user, by detecting an amount of the changed capacitance of the operation portion area.

The light source 5 is, for example, a LED that emits light having a predetermined color. The plural light sources 5 are provided to the operation portion area of the display apparatus 1. In other words, the plural light sources 5 are provided near the operation surface of the touch panel 3. The light sources 5 emit light in different states depending on the proximity state of the user to the touch panel 3. For example, the light sources 5 emit light having different colors depending on whether one finger (one point) or the more than one finger (plural points) is located in proximity to the touch panel 3 or the operation portion area by the user. A state in which the one finger or the one point is located in proximity to the touch panel 3 or the operation portion area by the user is hereinafter referred to as one-finger proximity or one-point proximity. Similarly, a state in which the more than one finger or the plural points are located in proximity to the touch panel 3 or the operation portion area by the user is hereinafter referred to as plural-finger proximity or plural-point proximity.

Due to the light emitted by the light sources 5, the user can understand that the display apparatus 1 is ready to receive the close range operation. The user can also understand a function ready to be received, among the functions of the display apparatus 1, based on a displayed color of the operation portion area. In other words, the user can understand whether or not the display apparatus 1 is ready to receive the close range operation to execute a user objective function, among the plural functions that can be executed by the close range operation. Moreover, since the light sources 5 are provided near the operation surface of the touch panel 3, the user can understand whether or not the type of the close range operation corresponding to the user objective function can be received, seeing a displayed state of the display surface of the display 2.

The detection part 10 is connected to the electrodes provided to the operation surface of the touch panel 3 and the electrodes provided to the operation portion area. The detection part 10 is a sensor that detects the changed capacitance of the electrodes. The detection part 10 includes, e.g., a hardware circuit. Moreover, the detection part 10 includes a contact detector 10a and a proximity detector 10b. The contact detector 10a detects the changed capacitance caused by touching the operation surface of the touch panel 3 with at least one finger of the user. Moreover, the proximity detector 10b detects the changed capacitance caused by the one-finger proximity or the plural-finger proximity to the operation surface of the touch panel 3 or the operation portion area.

Concretely, using a mutual capacitive method, the contact detector 10a detects the changed capacitance caused when the user touches the operation surface of the touch panel 3 with the finger. The mutual capacitive method is a method that measures a change in capacitance between a drive electrode and a receive electrode. In other words, the contact detector 10a detects the changed capacitance caused when the user touches the touch panel 3, based on reduction of electrical charge received by the receive electrode due to the finger of the user blocking an electric field.

Using a self capacitive method, the proximity detector 10b detects the changed capacitance caused when the finger is located in proximity to the operation surface of the touch panel 3 or the operation portion area by the user. The self capacitive method is a method that measures a change in stray capacitance that changes depending on capacitance caused between the finger tip and an electrode when the finger is located in proximity to the electrode. Moreover, the capacitance caused between the finger tip and the electrode varies, depending on whether one finger or the more than one finger is located in proximity. Therefore, when the user locates one finger in proximity to the operation surface of the touch panel 3 or the operation portion area, the proximity detector 10b detects an amount of the changed capacitance different from an amount of the changed capacitance detected when the user locates the more than one finger in proximity to the operation surface of the touch panel 3 or the operation portion area.

As mentioned above, the proximity detector 10b detects the user proximity to the operation surface of the touch panel 3 or the operation portion area and also detects whether the user proximity is the one-finger proximity or the plural-finger proximity. Herein, the term of more than one finger means, for example, two fingers next to each other of one hand of the user.

The memory 11 is a non-volatile storage, such as a flash memory, that can store different types of data. Various data required to run the display apparatus I and a program 11a are stored in the memory 11.

Using a map stored in the memory 11, the navigation part 12 executes the navigation function that provides a route to a destination. Moreover, using audio data stored in the memory 11, the audio part 13 executes the audio function that outputs sound via the speaker 14.

The controller 20 controls the entire display apparatus 1. The controller 20 is, for example, a microcomputer including a CPU, a RAM and a ROM. Each function of the controller 20 is implemented by execution of the program 11a stored in the memory 11 by the CPUs. Such a program 11a is obtained, for example, by readout from a recording medium, such as a memory card, and is stored in the memory 11 beforehand. In a case where the display apparatus 1 includes a communication function via a network, the program 11a may be obtained via communication with another communication apparatus.

Moreover, the controller 20 includes a display controller 20a, an obtaining part 20b, a light emission part 20c, and a receiver 20d, which are a part of the functions of the controller 20 implemented by execution of the program 11a.

The display controller 20a controls display of images and the like displayed on the display 2. The display controller 20a causes the display 2 to display on the display surface, for example, a map image and the command button that serves as a mark used by the user when performing the contact operation or the close range operation.

The obtaining part 20b receives a signal relating to the changed capacitance detected by the contact detector 10a. The obtaining part 20b obtains position information about a position that the user has touched, based on the received signal relating to the changed capacitance. The position information is information about one particular position on the operation surface of the touch panel 3 and the operation portion area.

Moreover, the obtaining part 20b also receives a signal relating to the changed capacitance detected by the proximity detector 10b. The obtaining part 20b obtains information about number of the fingers that the user locates in proximity to the operation surface of the touch panel 3 or the operation portion area and the position information of the finger, based on the received signal relating to the changed capacitance. In other words, the obtaining part 20b obtains information about whether the user proximity is the one-finger proximity or the plural-finger proximity. The one-finger proximity and the plural-finger proximity may be regarded as two types of proximity and accordingly there are two types of the close range operation: one of which is the close range operation of the one-finger proximity and the other is the close range operation of the plural-finger proximity. Moreover, the position information in this case is information about one particular position on the operation surface of the touch panel 3 and the operation portion area.

Since the finger tip of the user has a certain surface area, when the user locates the finger in proximity to the operation surface of the touch panel 3, capacitance of a certain area of the operation surface is changed. Therefore, the obtaining part 20b obtains information about a certain area as the position information in both cases of the one-finger proximity or the plural-finger proximity.

As mentioned above, the amounts of the changed capacitance are different depending on whether the user proximity is the one-point proximity or the plural-point proximity to the operation surface of the touch panel 3 or the operation portion area. For example, the amount of the changed capacitance caused by the plural-point proximity is larger than the amount of the changed capacitance caused by the one-point proximity. Therefore, the obtaining part 20b discriminates between the one-point proximity and the plural-point proximity, based on the signal relating to the changed capacitance received from the proximity detector 10b.

The light emission part 20c controls the light sources 5 to emit light. As mentioned above, the light sources 5 emit light in different states, depending on whether the user proximity is the one-point proximity or the plural-point proximity to the operation surface of the touch panel 3 or the operation portion area. Therefore, the light emission part 20c causes the light sources 5 to emit light having a color corresponding to number of the points located in proximity. For example, in a case where the user proximity is the plural-point proximity, the light emission part 20c causes the light sources 5 to emit green light. In a case where the user proximity is the one-point proximity, the light emission part 20c causes the light sources 5 to emit orange light. Thus, the user can understand whether or not the display apparatus 1 is ready to receive one of the two types of the close range operation corresponding to the user objective function among the plural functions that can be executed by the close range operation.

In other words, the light emission part 20c causes the light sources 5 to emit light in different colors, depending on whether the user proximity is the one-point proximity or the plural-point proximity. As a result, the user can understand whether or not the display apparatus 1 is ready to receive the close range operation to execute the function corresponding to number of the fingers (points) located in proximity, among the functions of the display apparatus 1. For example, the close range operation of the one-finger proximity is set to execute the audio function, and the close range operation of the plural-finger proximity is set to execute the navigation function.

The receiver 20d receives a command associated with the position that the user has touched or with the proximity position of the user. In a case where the user performs the contact operation, the receiver 20d receives a signal relating to the position information about the position on the touch panel 3 touched by the user, from the obtaining part 20b, and receives a command associated with the position. For example, when the user touches an area where a command button is displayed, the receiver 20d receives the signal related to the position information about the touched position from the obtaining part 20b. Then, based on the received signal, the receiver 20d receives a command associated with the position (command button). Moreover, when the user touches one particular operation portion 4, the receiver 20d receives the signal relating to the position information about the touched position from the obtaining part 20b, and receives a command associated with the particular operation portion 4. In other words, the receiver 20d receives the command associated with the particular hard button with which the user has performed the contact operation.

In a case where the user performs the close range operation, the receiver 20d receives a signal relating to the position information about the proximity position of the user to the touch panel 3, from the obtaining part 20b, and receives a command associated with the position. For example, in a case of the user proximity to the area where the command button is displayed, the receiver 20d receives the signal related to the position information about the proximity position of the user. Then, based on the received signal, the receiver 20d receives the command associated with the position (command button). Moreover, in a case of the user proximity to one particular operation portion 4, the receiver 20d receives the signal relating to the position information about the proximity position of the user from the obtaining part 20b, and receives a command associated with the particular operation portion 4. In other words, the receiver 20d receives the command associated with the particular hard button with which the user has performed the close range operation.

<1-3. Process Flow>

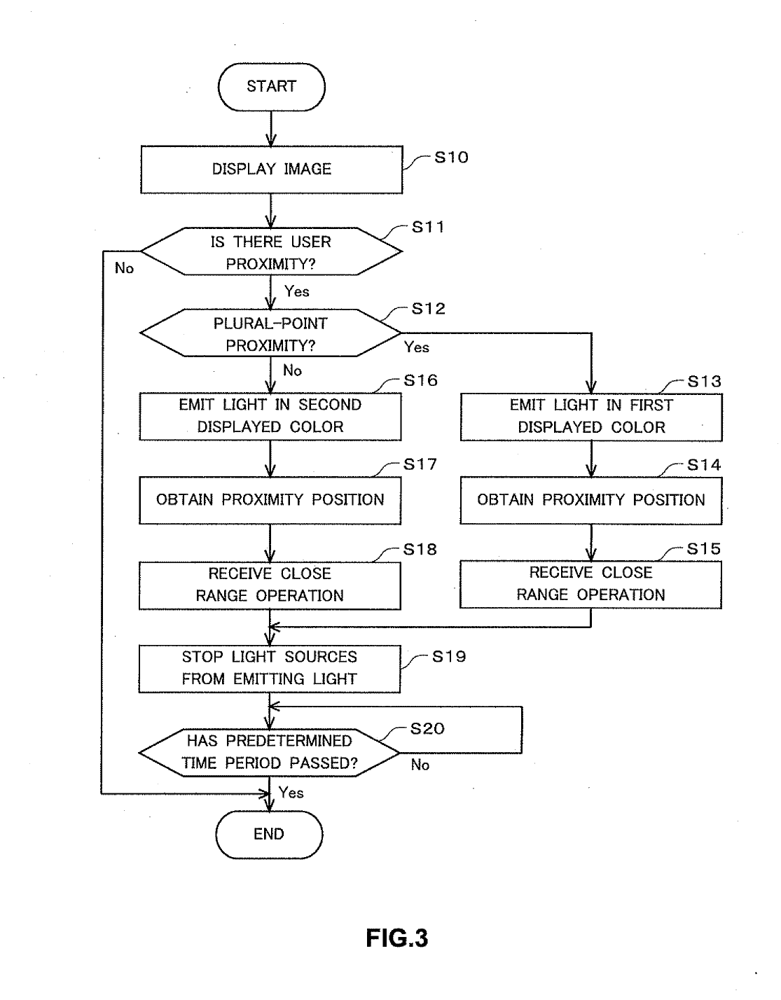

Next described is a flow of a process performed by the display apparatus 1. FIG. 3 is a flowchart illustrating the process performed by the display apparatus 1.

First, the display controller 20a displays an image on the display surface of the display 2 (a step S10). The image displayed is, for example, a map image. Next, the obtaining part 20b determines whether or not there is the user proximity to the operation surface of the touch panel 3 or the operation portion area (a step S11). Concretely, the proximity detector 10b detects the changed capacitance between the finger tip of the user and the electrode provided to the operation surface of the touch panel 3 or the operation portion area. Then the obtaining part 20b receives the signal relating to the changed capacitance and then determines whether or not at least one finger of the user is located in proximity to the operation surface of the touch panel 3 or the operation portion area, based on the received signal.

In a case where there is no user proximity (No in the step S11), the process ends. In this case, any finger is not located in proximity to the operation surface of the touch panel 3 by the user. However, the process may continue and the obtaining part 20b may perform a process, for example, for determining whether or not the user has performed the contact operation. On the other hand, in a case where there is the user proximity (Yes in the step S11), the obtaining part 20b determines whether or not the user proximity is the plural-point proximity (a step S12).

Concretely, based on the received signal relating to the changed capacitance, the obtaining part 20b compares the changed capacitance with a predetermined value. The predetermined value is a threshold for determining that the user proximity is the one-point proximity or the plural-point proximity. The amount of the changed capacitance caused by the one-finger proximity is different from the amount of the changed capacitance caused by the plural-finger proximity. Therefore, the threshold may be set to a value that can discriminate between the amounts of the changed capacitance. In a case where the amount of the changed capacitance is greater than the threshold, the obtaining part 20b determines that the user proximity is the plural-point proximity, and in a case where the amount of the changed capacitance is less than the threshold, the obtaining part 20b determines that the user proximity is the one-point proximity.

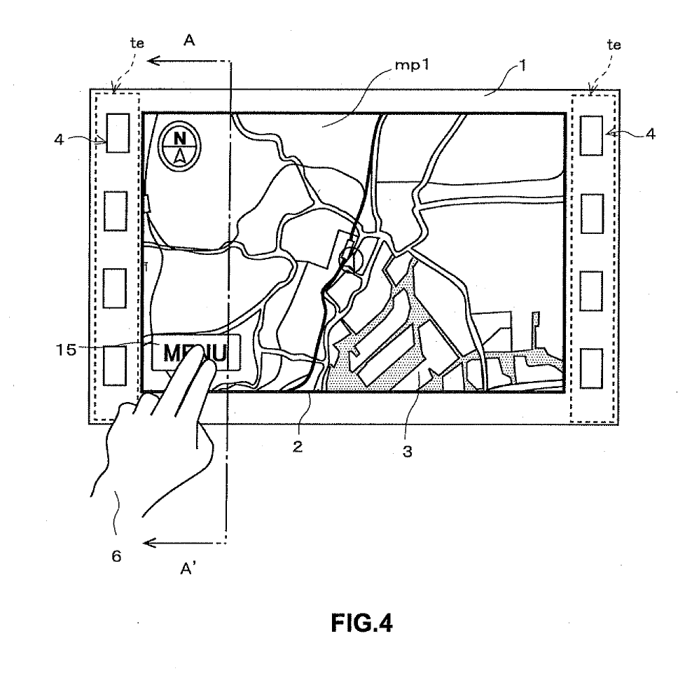

Here, steps for determining whether or not there is the user proximity and for determining number of the points located in proximity (the steps S11 and S12) are explained, with reference to FIG. 4 to FIG. 7B.

FIG. 4 illustrates an example of the plural-point proximity of the user 6 to the operation surface of the touch panel 3. FIG. 4 shows a map image mp 1 displayed on the display 2 after execution of the navigation function of the display apparatus 1. Moreover, a command button 15 is superimposed and displayed on the map image mp1. Furthermore, the user 6 locates the two fingers next to each other, in proximity to the operation surface of the touch panel 3. In this case, the proximity detector 10b detects the changed capacitance caused by the plural-point proximity to the operation surface of the touch panel 3.

Further, the steps are explained with reference to a side view of the display apparatus 1. FIG. 5A and FIG. 5B are sectional views showing a section along line A-A′ of the display apparatus 1. FIG. 5A illustrates that the more than one finger is located at a non-proximity position to the touch panel 3 by the user 6. FIG. 5B illustrates that the more than one finger is located at the proximity position to the touch panel 3 by the user 6. The proximity position herein is a position within a range a predetermined distance away from the operation surface of the touch panel 3 (hereinafter referred to as predetermined distance range). The predetermined distance range is a range, e.g., 0.2 cm to 2.0 cm away from the operation surface of the touch panel 3. Therefore, the proximity state means that the finger tip of the user 6 is located in the range. On the other hand, the term “non-proximity position” means a position outside the predetermined distance range, and, for example, is a position more than 2.0 cm away from the operation surface of the touch panel 3. Therefore, when the finger tip of the user 6 is located outside the predetermined distance range, the user is not in the proximity state.

When the more than one finger is moved from the non-proximity position to the proximity position to the touch panel 3 (from a state shown in FIG. 5A to a state shown in FIG. 5B) by the user 6, capacitance between the finger tips of the user 6 and the electrode provided to the touch panel 3 changes. In other words, as a distance between the finger tips of the user 6 and the electrode becomes smaller, the capacitance increases. The proximity detector 10b detects the changed capacitance and outputs the signal relating to the changed capacitance to the obtaining part 20b.

As mentioned above, the more the fingers of the user 6 located at the proximity position, the more the capacitance between the finger tips of the user 6 and the electrode provided to the touch panel 3. In other words, the larger the area of the finger tips of the user 6, the more the capacitance between the finger tips and the electrode. The proximity detector 10b detects the changed capacitance caused by the user proximity to the operation surface of the touch panel 3, and sends the signal relating to the changed capacitance to the obtaining part 20b. When receiving the signal relating to the changed capacitance greater than the threshold, the obtaining part 20b determines that the user proximity is the plural-point proximity.

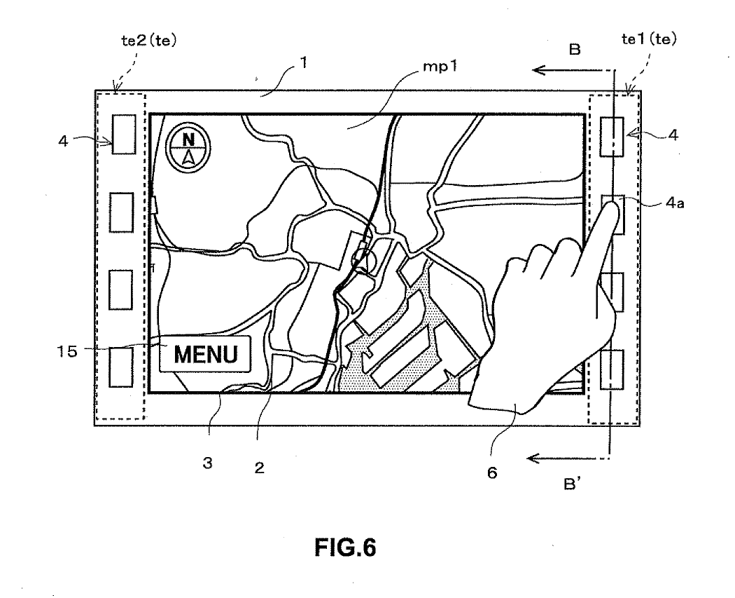

FIG. 6 illustrates an example of the one-point proximity to an operation portion area te. Like FIG. 4, FIG. 6 shows the map image mp 1 displayed on the display 2 after execution of the navigation function of the display apparatus 1. Moreover, the command button 15 is superimposed and displayed on the map image mp 1. Furthermore, the user 6 locates one finger in proximity to the operation portion area te. In this case, the proximity detector 10b detects the changed capacitance caused by the one-point proximity to the operation portion area te.

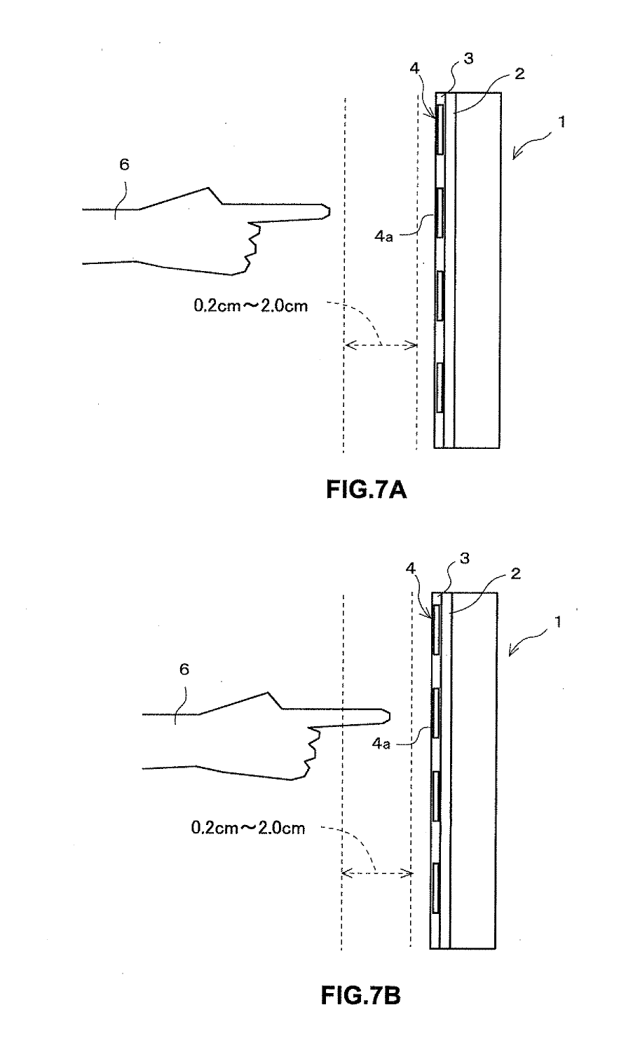

Further, the steps are explained with reference to a side view of the display apparatus 1. FIG. 7A and FIG. 7B are sectional views showing a section along line B-B′ of the display apparatus 1. FIG. 7A illustrates that the one finger is located at the non-proximity position to the operation portion area te by the user 6. FIG. 7B illustrates that the one finger is located at the proximity position to the operation portion area te by the user 6. Definitions of the terms “non-proximity position” and “proximity position” are the same as the definitions used to explain with reference to FIG. 5A and 5B.

When the one finger is moved from the non-proximity position to the proximity position to the operation portion area te (from a state shown in FIG. 7A to a state shown in FIG. 7B) by the user 6, capacitance between the finger tip of the user 6 and the electrode provided to the operation portion area te changes. In other words, as a distance between the finger tip of the user 6 and the electrode becomes smaller, the capacitance increases. The proximity detector 10b detects the changed capacitance and outputs the signal relating to the changed capacitance to the obtaining part 20b.

The changed capacitance caused by the one-finger proximity of the user 6 is smaller than the changed capacitance caused by the plural-finger proximity of the user 6. The proximity detector 10b detects the changed capacitance caused by the user proximity to the operation portion area te, and sends the signal relating to the changed capacitance to the obtaining part 20b. Once receiving the signal relating to the changed capacitance less than the threshold, the obtaining part 20b determines that the user proximity is the one-point proximity.

With reference back to FIG. 3, in a case of the plural-point proximity of the user 6 (Yes in the step S12), the light emission part 20c causes the light sources 5 to emit light having a first displayed color (a step S13). The first displayed color is a color, e.g., green, of the light emitted in the case of the plural-point proximity of the user 6 to the operation surface of the touch panel 3 or the operation portion area te.

Then the obtaining part 20b obtains information about the proximity position that is a position of the user proximity of the user 6 (a step S14). Concretely, based on the relating to the changed capacitance, the obtaining part 20b obtains the position information about one particular position on the operation surface of the touch panel 3 or the operation portion area te in the case of the plural-point proximity of the user 6. The obtained position information represents the proximity position of the user 6 to the touch panel 3 or the operation portion area te, such as the area corresponding to the command button 15.

Then the receiver 20d receives the command associated with the proximity position (a step S15). Concretely, the receiver 20d receives the information about the proximity position from the obtaining part 20b, and receives the command associated with the proximity position based on the information. In other words, in a case where the proximity position is the area corresponding to the command button 15, the receiver 20d receives the command associated with the command button 15.

On the other hand, in the case of the one-point proximity of the user 6 (No in the step S12), the light emission part 20c causes the light sources 5 to emit light having a second displayed color (a step S16). The second displayed color is a color, e.g., orange, of the light emitted in the case of the one-point proximity of the user 6 to the operation surface of the touch panel 3 or the operation portion area te.

Then the obtaining part 20b obtains information about the proximity position that is a position of the user proximity of the user 6 (a step S17). Concretely, based on the signal relating to the changed capacitance, the obtaining part 20b obtains the position information about one particular position on the operation surface of the touch panel 3 or the operation portion area te in the case of the one-point proximity of the user 6. The obtained position information represents the proximity position of the user 6 to the touch panel 3 or the operation portion area te, such as a position corresponding to the operation portion 4 (hard button).

Then the receiver 20d receives the command associated with the proximity position (a step S18). Concretely, the receiver 20d receives the information about the proximity position from the obtaining part 20b, and receives the command associated with the proximity position based on the information. In other words, in a case where the proximity position is the position corresponding to the hard button, the receiver 20d receives the command associated with the hard button.

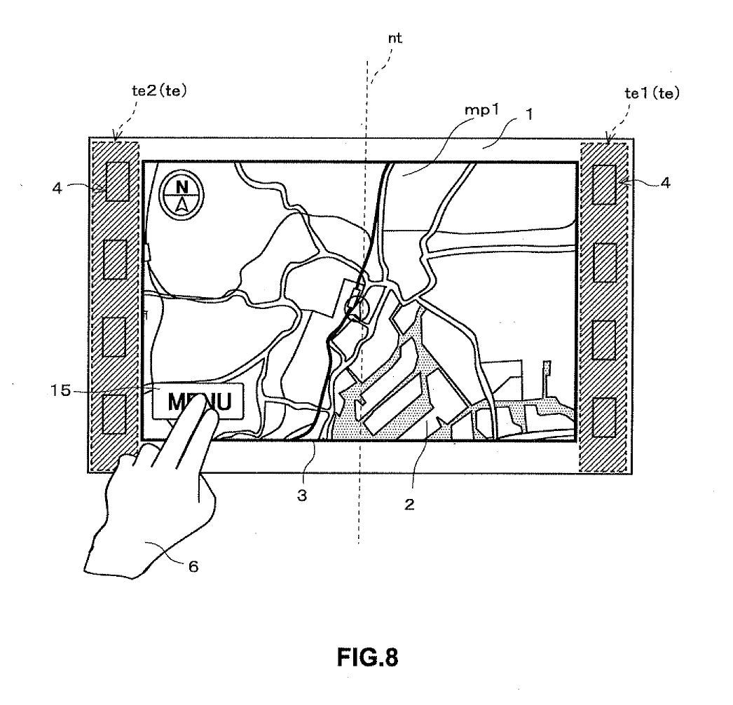

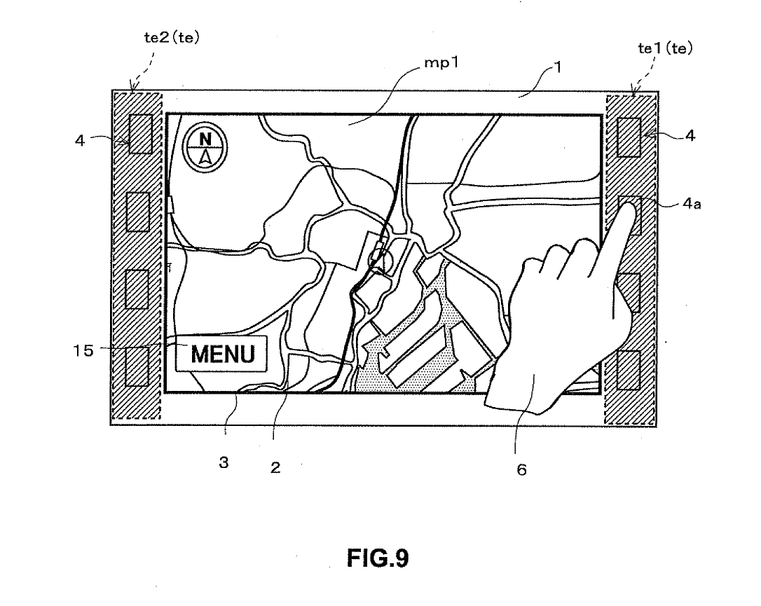

The steps from the step of causing the light sources 5 to emit light to the step of receiving the command (from the step S13 to the step S18) are hereinafter explained with reference to FIG. 8 and FIG. 9. FIG. 8 and FIG. 9 illustrate states where the light sources 5 provided to the operation portion area te are emitting light.

As shown in FIG. 8, in the case of the plural-point proximity of the user 6 to the operation surface of the touch panel 3 or the operation portion area te, the light emission part 20c causes the light sources 5 to emit light having the first displayed color (e.g. green) corresponding to the plural-point proximity. In other words, when the more than one finger of the user 6 is moved into the predetermined distance range the predetermined distance away from the operation surface of the touch panel 3, the light emission part 20c causes the light sources 5 to emit light having the color corresponding to the plural-finger proximity

As a result, the operation portion area te to which the light sources 5 are provided is displayed in the first displayed color. Therefore, the user 6 can understand that the display apparatus 1 is ready to receive the close range operation corresponding to the user objective function. For example, the user 6 moves the more than one finger closer to the operation surface of the touch panel 3 or the operation portion area te. When the operation portion area te is changed to the first displayed color, the user 6 understands that the display apparatus 1 is ready to receive the close range operation to execute a function (i.e. audio function) corresponding to the first displayed color. Moreover, based on the signal relating to the changed capacitance, the obtaining part 20b obtains the proximity position of the user 6. Furthermore, once receiving the signal relating to the proximity position of the user 6 from the obtaining part 20b, the receiver 20d receives the command associated with the proximity position.

FIG. 8 illustrates a state where the light sources 5 provided to the operation portion areas te on right and left sides relative to the touch panel 3 are emitting light. In addition to the case mentioned above, the light emission part 20c may cause the light sources 5 provided to one of the operation portion areas te on the right and left sides, to emit light having the first displayed color, in accordance with the position information obtained by the obtaining part 20b. For example, in a case where the position information obtained by the obtaining part 20b represents a position in a right side area of a center line nt that divides the operation surface of the touch panel 3 into the right side area and a left side area, the light emission part 20c causes the light sources 5 provided to a right side operation portion area te1 to emit light having the first displayed color. On the other hand, in a case where the position information obtained by the obtaining part 20b represents a position in the left side area of the center line nt, the light emission part 20c causes the light sources 5 provided to a left side operation portion area te2 to emit light having the first displayed color.

Concretely, when the obtaining part 20b obtains the position information corresponding to the command button 15, the light emission part 20c causes the light sources 5 provided to the left side operation portion area te2 on the left side viewed from the user 6, to emit light having the first displayed color. As mentioned above, since the light sources 5. provided to one of the right and left side areas to which the user 6 locates the fingers in proximity, emit light, the user 6 can easily understand that the display apparatus 1 is ready to receive the close range operation to execute a function corresponding to a particular position on the operation surface of the touch panel 3.

As shown in FIG. 9, in the case of the one-point proximity of the user 6 to the operation surface of the touch panel 3 or the operation portion area te, the light emission part 20c causes the light sources 5 to emit light having the second displayed color (e.g. orange) corresponding to the one-point proximity. In other words, when the one finger of the user 6 is moved into the predetermined distance range the predetermined distance away from the operation portion 4, the light emission part 20e causes the light sources 5 to emit light having the color corresponding to the one-finger proximity.

Thus the operation portion area te to which the light sources 5 are provided is displayed in the second displayed color. Therefore, the user 6 can understand that the display apparatus 1 is ready to receive the close range operation corresponding to the user objective function. For example, the user 6 moves one finger closer to the operation surface of the touch panel 3 or the operation portion area te. When the operation portion area te is changed to the second displayed color, the user 6 understands that the display apparatus 1 is ready to receive the close range operation to execute a function (i.e. navigation function) corresponding to the second displayed color. Moreover, based on the signal relating to the changed capacitance, the obtaining part 20b obtains the proximity position of the user 6. Furthermore, once receiving the signal relating to the proximity position of the user 6 from the obtaining part 20b, the receiver 20d receives the command associated with the proximity position.

FIG. 9 illustrates a state where the light sources 5 provided to the operation portion areas te on the right and left sides relative to the touch panel 3 are emitting light. Same as the case described with reference to FIG. 8, in FIG. 9, the light emission part 20c may cause the light sources 5 provided to one of the right side operation portion area te1 and the left side operation portion area te2 to emit light having the second displayed color, in accordance with the position information obtained by the obtaining part 20b. For example, in a case where the position information obtained by the obtaining part 20b represents a position of a hard button 4a, the light emission part 20c causes the light sources 5 provided to the right side operation portion area te1 to emit light. Thus the user 6 can easily understand that the display apparatus 1 is ready to receive the close range operation to execute a function corresponding to the hard button 4a (or a vicinity thereof).

With reference back to FIG. 3, after the receiver 20d receives the command associated with the proximity position, the light emission part 20c stops the light sources 5 from emitting light (a step S19). Thus the user 6 can understand that the close range operation performed by the user 6 has been received. Then the display apparatus 1 executes the function based on the received command.

When the user 6 operates the operation surface of the touch panel 3 by performing the close range operation with the plural points, the display apparatus 1 executes a function corresponding to the close range operation. For example, in a case where the close range operation with the plural points is set to execute the audio function and where the proximity position is associated with a command to display an audio screen, the display apparatus 1 displays the audio screen on the display 2. Moreover, when the user 6 operates the hard button 4a by performing the close range operation with one point, the display apparatus executes a function corresponding to the close range operation. For example, in a case where the close range operation with one point is set to execute the navigation function and where the proximity position is associated with a command to search a destination, the display apparatus 1 displays a search screen on the display 2.

Then the display apparatus 1 determines whether or not a predetermined time period has passed from execution of the function corresponding to the close range operation (a step S20). The predetermined time period is time required for the user 6 to move the finger to a position at which the finger is not in the proximity state, after the display apparatus 1 has received the close range operation performed by the user 6. In other words, the predetermined time period is time required for the user 6 to move the finger located in the predetermine distance range to a position outside the predetermine distance range. The predetermined time period is, for example, two seconds, but can be freely set.

If the display apparatus 1 is ready to receive the close range operation performed by the user 6 immediately after the execution of the function of the display apparatus 1, the display apparatus 1 may possibly detect a movement and the like of the finger of the user 6 immediately after the close range operation, as another close range operation. Therefore, the display apparatus 1 does, not receive the close range operation for the predetermined time period after the execution of the function corresponding to the close range operation and becomes ready to receive a next operation after the predetermined time period. Thus after completion of one close range operation by the user 6, an operation unintended by the user 6 is not executed before the finger is moved out of the predetermined distance range by the user 6.

In a case where the predetermined time period has passed (Yes in the step S20), the display apparatus 1 ends the process of the close range operation. On the other hand, in a case where the predetermined time has not passed (No in the step S20), the display apparatus 1 repeats the steps for determining whether or not the predetermined time period has passed. After the completion of the close range operation, the steps from the step S10 are repeated.

As mentioned above, when the user 6 operates the operation surface of the touch panel 3 or the operation portion area by performing the close range operation, the light emission part 20c causes the light sources 5 to emit light in different colors depending on number of the fingers located by the user 6. Thus the user 6 can understand that the display apparatus 1 is ready to receive the close range operation and also can understand that the display apparatus 1 is ready to execute the user objective function.

### 2. Second Embodiment

Next, a second embodiment is explained. The display apparatus in the first embodiment is configured to receive a command associated with a position of the finger of the user located in proximity to the operation surface of the touch panel or the operation portion area. However, a display apparatus may be configured to receive a command corresponding to a gesture operation performed by a user, instead of receiving the command by locating at least one finger of the user. Therefore, in the second embodiment, a configuration of the display apparatus that receives the gesture operation performed by the user is explained. The gesture operation refers to an operation in which the user moves at least one finger from a position to another position, keeping the finger in a proximity state to an operation surface of a touch panel or an operation portion area. In other words, the gesture operation refers to an operation in which the user moves at least one finger substantially parallel to the operation surface of the touch panel, etc., keeping the finger in proximity to the operation surface of the touch panel or the like.

<2-1. Configuration>

A display apparatus 1 in the second embodiment is substantially the same as the display apparatus 1 shown in FIG. 2. A proximity detector, an obtaining part, and a receiver in the second embodiment perform steps partially different from the steps in the first embodiment. Therefore, differences from the first embodiment are hereinafter mainly explained.

Using a self capacitive method, a proximity detector 10b detects changed capacitance caused by at least one finger of the user located in proximity to an operation surface of a touch panel 3 or an operation portion area. Like the proximity detector 10b in the first embodiment, the proximity detector 10b in the second embodiment detects user proximity to the operation surface of the touch panel 3 or the operation portion area and also detects whether the user proximity is one-finger proximity or plural-finger proximity. Moreover, the proximity detector 10b in the second embodiment detects changed capacitance caused by travel of the finger when the user performs the gesture operation.

Based on a signal relating to the changed capacitance detected by a contact detector 10a, an obtaining part 20b obtains position information about a position which the user has touched. The position information is information about a position on the operation surface of the touch panel 3 and the operation portion area. Moreover, when the user performs the gesture operation, the obtaining part 20b also receives a signal relating to the changed capacitance caused by the travel of the finger of the user detected by the proximity detector 10b. Based on the signal relating to the changed capacitance, the obtaining part 20b obtains information about number of the fingers located in proximity by the user. Furthermore, the obtaining part 20b obtains the position information about a position of the fingers of the user before, after and during the travel, based on the signals relating to the changed capacitance.

A receiver 20d receives a command associated with the position that the user has touched or with a proximity position of the user. In a case where the user performs a close range operation, the receiver 20d receives a signal relating to the position information about the position on the touch panel 3 to which the user locates the finger in proximity, from the obtaining part 20b, and receives the command associated with the position. In a case where the user performs the gesture operation, the receiver 20d receives a command associated with the proximity position of the finger located before or after the gesture operation.

<2-2. Process Flow>

Next described is a flow of a process performed by the display apparatus 1 in the second embodiment. In the second embodiment, once detecting the user proximity, the display apparatus 1 causes light sources 5 to emit light. After the gesture operation is performed by the user, the display apparatus 1 receives the command based on the position information. In other words, except a step for the gesture operation added after the step S13 and the step S16 shown in FIG. 3, the process performed by the display apparatus 1 in the second embodiment is the same as the steps from the step S10 to the step S20 performed by the display apparatus 1 in the first embodiment. In the second embodiment, steps from a S12 to a S19 are explained.

The obtaining part 20b, like the obtaining part 20b in the first embodiment, determines whether or not the user proximity is plural-point proximity (the step S12). In a case of the plural-point proximity (Yes in the step S12), a light emission part 20c causes the light sources 5 to emit light having a first displayed color (a step S13). This step is also the same as the step S13 in the first embodiment.

After the step S13, the user performs the gesture operation and the proximity detector 10b detects the changed capacitance caused by the gesture operation. In other words, when the user performs the gesture operation with the more than one finger after the light sources 5 emit lights, the proximity detector 10b detects the changed capacitance caused by the travel of the fingers of the user. Then the obtaining part 20b obtains information about the proximity position of the user (a step S14). Concretely, based on the signal relating to the changed capacitance received from the proximity detector 10b, the obtaining part 20b obtains the position information before and/or after the gesture operation. Moreover, the obtaining part 20b may obtain the position information during the gesture operation.

Then the receiver 20d receives the command associated with the proximity position (a step S15). In a case where it is set to receive a command associated with the proximity position of the fingers located before the gesture operation, the receiver 20d receives the command associated with the proximity position of the fingers located before the user performs the gesture operation. Moreover, in a case where it is set to receive a command associated with the proximity position of the fingers located after the gesture operation, the receiver 20d receives the command associated with the proximity position of the fingers located after the user performs the gesture operation.

For example, in the case where it is set to receive the command associated with the proximity position of the fingers located after the gesture operation, the obtaining part 20b obtains information about a position of the fingers located after continuous travel from a position to another position in proximity to the operation surface of the touch panel 3 (after the gesture operation). Then the receiver 20d receives the command associated with the position information of the fingers located after the travel.

In the case where it is set to receive the command associated with the proximity position of the fingers located before the gesture operation, the obtaining part 20b obtains information about a position of the fingers located in proximity to the operation surface of the touch panel before the continuous travel. Then when the obtaining part 20b determines, based on the signal relating to the changed capacitance, that the user has performed the gesture operation, the receiver 20d receives the command associated with the proximity position of the fingers located before the gesture operation.

Moreover, in a case of one-point proximity (No in the step S12), the light emission part 20c causes the light sources 5 to emit light having a second displayed color (a step S16). This step is also the same as the step S16 in the first embodiment. Then the obtaining part 20b obtains the position information of the user proximity (a step S17). Concretely, when the user performs the gesture operation with one finger after the light sources 5 emit lights, the proximity detector 10b detects the changed capacitance caused by the travel of the finger of the user. Then based on the signal relating to the changed capacitance, the obtaining part 20b obtains the position information before and/or after the gesture operation.

Then the receiver 20d receives the command associated with the proximity position (a step S18). This step is the same as the step in the case of the plural-finger proximity mentioned above. Then, when the receiver 20d receives the command associated with the proximity position, the light emission part 20c stops the light sources 5 from emitting light (the step S19).

As mentioned above, after the one-finger proximity or the plural-finger proximity of the user, the obtaining part 20b detects the user proximity and the light sources 5 emit light before the gesture operation is performed. Therefore, the user can understand that the display apparatus 1 is ready to receive the gesture operation.

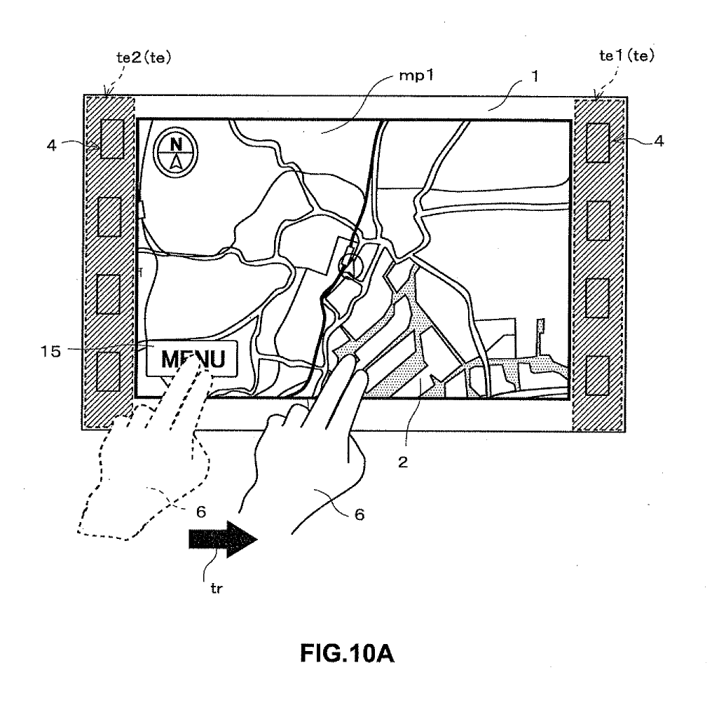

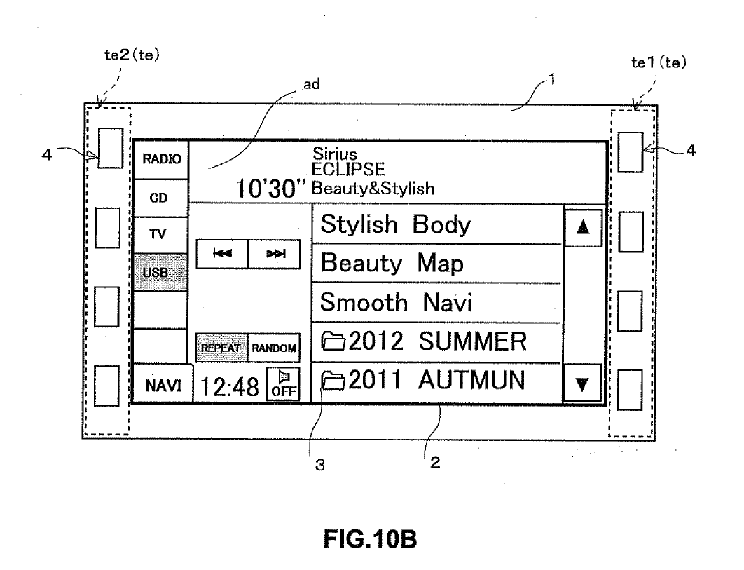

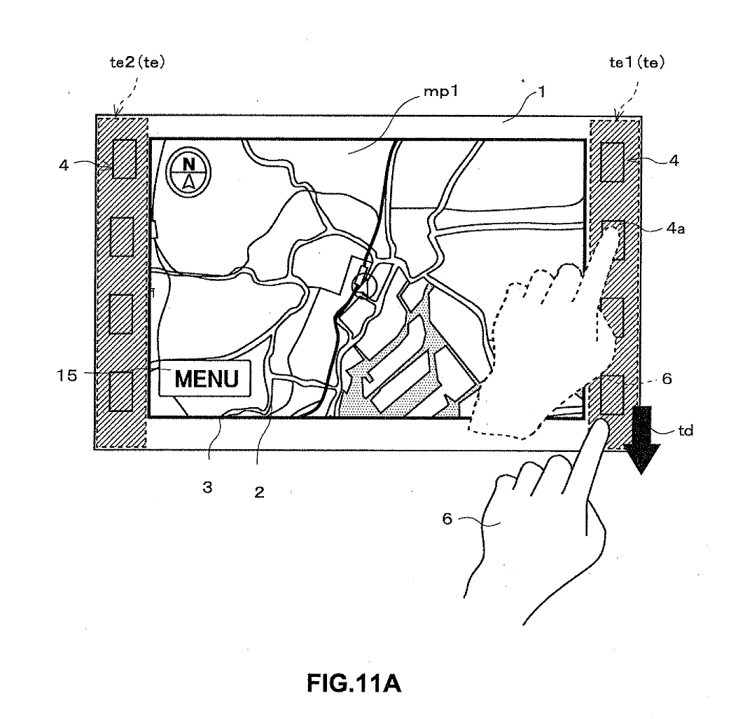

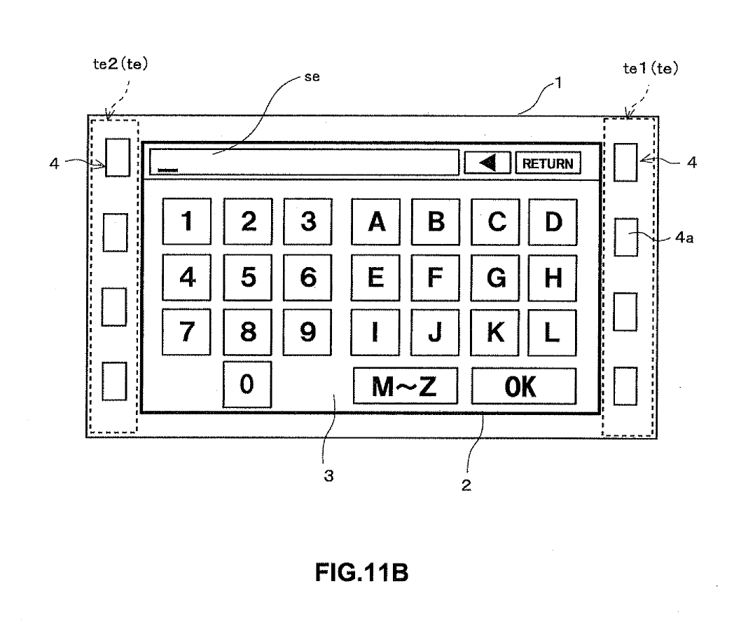

Next explained with reference to FIG. 10A to FIG. 11B is a process where the user executes a function of the display apparatus 1 by the gesture operation. The drawings from FIG. 10A to FIG. 11B show examples where the function of the display apparatus 1 is executed by the gesture operation.

FIG. 10A illustrates the gesture operation with the more than one finger. Moreover, FIG. 10B illustrates an example of a screen displayed after the display apparatus 1 executes the function. As shown in FIG. 10A, a user 6 locates in proximity the more than one finger at a position corresponding to a command button 15 on the operation surface of the touch panel 3. The user 6 moves the located more than one finger in a right direction (a direction of an arrow tr) from the position, substantially parallel to the operation surface. Thus the gesture operation executes the function.

In a case of the plural-finger proximity of the user 6, the light sources 5 emit light having a color corresponding to the more than one finger. Then, when the user 6 performs the gesture operation, a command corresponding to the gesture operation of the plural-finger proximity is received. For example, in the case where it is set to receive the command associated with the proximity position of the fingers located before the gesture operation, the receiver 20d receives the command associated with the position of the command button 15 after the user 6 performs the gesture operation. Moreover, in the case where it is set to receive a command associated with the proximity position of the fingers located after the gesture operation, the receiver 20d receives the command associated with the command button 15 after the user 6 locates the fingers at an arbitrary position in proximity to the operation surface and then moves the fingers to the command button 15 by the gesture operation.

Once receiving the command, the display apparatus 1 stops the light sources 5 to emit light and executes a function corresponding to the command. In a case where an audio function is associated with the plural-point proximity, if receiving a command to display an audio screen on a display 2, the display apparatus 1 changes a screen displayed on the display 2 to the audio screen shown in FIG. 10B from a map image mp1 shown in FIG. 10A. Thus the user 6 can execute the function corresponding to number of fingers located in proximity.

FIG. 11A illustrates the gesture operation with one finger. Moreover, FIG. 11B illustrates an example of a screen displayed after the display apparatus 1 executes the function. As shown in FIG. 11A, the user 6 locates in proximity one finger at a position corresponding to a hard button 4a on an operation portion area te. The user 6 moves the located one finger downward (a direction of an arrow td) from the position, substantially parallel to the operation portion area te. Thus the gesture operation executes the function.

In a case of the one-finger proximity of the user 6, the light sources 5 emit light having a color corresponding to one finger. Then, when the user 6 performs the gesture operation, a command corresponding to the gesture operation of the one-finger proximity is received. For example, in the case where it is set to receive the command associated with the proximity position of the finger before the gesture operation, the receiver 20d receives the command associated with the position of the hard button 4a after the user 6 performs the gesture operation. Moreover, in the case where it is set to receive the command associated with the proximity position of the finger located after the gesture operation, the receiver 20d receives the command associated with the hard button 4a after the user 6 locates the finger at an arbitrary position in proximity to the operation portion area and then moves the finger to the hard button 4a by the gesture operation.

Once receiving the command, the display apparatus 1 stops the light sources 5 to emit light and executes a function corresponding to the command. In a case where a navigation function is associated with the one-point proximity, if receiving a command to search a destination, the display apparatus 1 changes a screen displayed on the display 2 to a destination setting screen se shown in FIG. 11B from the map image mp1 shown in FIG. 11A. Thus the user 6 can execute the function corresponding to number of fingers located in proximity.

As mentioned above, in this invention, functions to be executed are associated with number of fingers located in proximity, and the light sources emit light in different colors depending on the number of the fingers located in proximity. Moreover, in the second embodiment, the function of the display apparatus 1 is executed after the gesture operation. Thus, in the case of the close range operation, understanding a function ready to be executed by the close range operation, the user can execute the function of the display apparatus 1.

### 3. Modification

The embodiments of the invention are described above. However, the invention is not limited to the embodiments described above, but various modifications are possible. Some modifications are hereinafter described. Forms of the embodiments described above and below may be combined arbitrarily.

The embodiments described above explain the display apparatus by citing the examples of the close range operation performed to the operation surface of the touch panel with more than one finger and of the close range operation performed to the operation portion area with one finger. However, the display apparatus may receive the close range operation performed to the operation portion area with the more than one finger and the close range operation performed to the operation surface of the touch panel with one finger. In other words, in both cases of the one-finger proximity and the plural-finger proximity, the user can perform the close range operation both to the operation surface of the touch panel and the operation portion area.

Moreover, in the embodiments described above, the display apparatus detects changed capacitance, using the self capacitive method. Based on the detected result, the display apparatus detects the user proximity. However, the display apparatus may detect the user proximity in a method other than the self capacitive method, such as an infrared method.. When using the infrared method, the invention may also be applied to a display apparatus not including a touch panel. In this case, a user performs the close range operation to a display surface.

Moreover, in the embodiments described above, the display apparatus has the configuration where the electrodes are provided to the operation surface of the touch panel and the operation portion area, and where in both cases of the user proximity to the operation surface and the user proximity to the operation portion area, the proximity detector detects changed capacitance. However, the display apparatus may have a configuration where electrodes are provided only to an operation surface of a touch panel and where a proximity detector detects changed capacitance only in a case of user proximity to the operation surface of the touch panel. In this case, an obtaining part obtains information about whether the user proximity is one-point proximity or plural-point proximity and information about a proximity position of the user. Then a light emission part causes light sources to emit light in different colors depending on whether the user proximity is the one-point proximity or the plural-point proximity. Thus the user can understand whether or not the display apparatus 1 is ready to receive the close range operation corresponding to a user objective function.

Moreover, the display apparatus may have a configuration where electrodes are provided only to an operation portion area and where a proximity detector detects changed capacitance only in a case of user proximity to the operation portion area. In this case, an obtaining part obtains information about whether the user proximity is one-point proximity or plural-point proximity and information about a proximity position of the user. Then a light emission part causes light sources to emit light in different colors depending on whether the user proximity is the one-point proximity or the plural-point proximity. Thus the user can understand whether or not the display apparatus 1 is ready to receive the close range operation corresponding to a user objective function.

Furthermore, in the embodiments described above, the display apparatus has the configuration where in both cases of the user proximity to the operation surface or the user proximity to the operation portion area, the display apparatus 1 causes the light sources to emit light in different colors depending on whether the user proximity is the one-point proximity or the plural-point proximity. However, the display apparatus may have a configuration where in a case of plural-point proximity, the display apparatus causes light sources provided to an operation surface of a touch panel to emit light having a first displayed color and where in a case of one-point proximity, the display apparatus causes the light sources provided to an operation portion area to emit light having a second displayed color. Moreover, contrarily, the display apparatus may have a configuration where in the case of the one-point proximity, the display apparatus causes the light sources of the operation surface of the touch panel to emit light having the second displayed color, and where in the case of the plural-point proximity, the display apparatus causes the light sources of the operation portion area to emit light having the first displayed color.

Further, the embodiments described above explain the configuration where the light sources emit light in different displayed colors, as an example of the different states of the light sources emitting light. However, the different states of the light sources emitting light is not limited to the different displayed colors but the display apparatus may have a configuration that emits light for different time periods. Examples of the different states may be a state where the light is kept turned on and a state where the light is turned on and off repeatedly in a predetermined cycle.

Moreover, the embodiments described above explain the configuration where when the obtaining part obtains the information about the user proximity based on changed capacitance, the light emission part causes the light sources to emit light. However, the display apparatus may have a configuration where after a receiver receives the close range operation performed by a user, a light emission part causes light sources to emit light.

Furthermore, the embodiments described above explain the configuration where the light sources are provided to the operation portion areas on the right and left sides relative to the touch panel of the display apparatus 1. However, the display apparatus may have a configuration where light sources are provided to one of operation portion areas on a right side and a left side, or where the light sources are provided to one or both of the operation portion areas on an upper side and a lower side relative to the touch panel of the display apparatus. Furthermore, the light sources may be provided to the operation portion areas on all of the four upper, lower, right and left sides. In this case, conditions to cause the light sources on each side of the four sides to emit light may be different from each other, depending on contents of user operations made with a touch panel.

Further, the embodiments described above explain the configuration that causes the light sources provided to the operation portion area, to emit light in the case of the user proximity to the operation portion. However, the display apparatus may have a configuration where a light source is provided to each operation portion and where in a case of user proximity to one of the operation portions, only the light source provided to the one operation portion emits light.

Further, the embodiments described above explain the configuration that informs the user of whether the user proximity is the one-point proximity or the plural-point proximity, by emitting light in different colors. However, the display apparatus may inform the user in a different method. For example, the display apparatus may have a configuration that outputs different types of sound from a speaker or a configuration that displays different screens on a display, depending on whether user proximity is one-point proximity or plural-point proximity.

Further, the embodiments described above explain the configuration that causes the light sources to emit light in the case of the user proximity to the operation surface of the touch panel or the operation portion area. However, the display apparatus may have a configuration that causes light sources to emit light in a case where a user touches an operation surface of a touch panel or an operation portion area. In this case, a light emission part may cause the light sources to emit light in different states depending on whether the user has touched with one point or plural points. Moreover, the display apparatus may have a configuration where in the case where the user touches the operation surface of the touch panel or the operation portion area, the display apparatus 1 is vibrated by driving a motor provided inside the display apparatus 1. In this case, the display apparatus 1 may be vibrated in different types of vibration depending on whether the user has touched with one point or plural points.

Further, the second embodiment described above explains the configuration that the display apparatus 1 receives, after the gesture operation, a command associated with the proximity position of at least one finger located before or after the gesture operation. On the other hand, the display apparatus 1 may have a configuration where the display apparatus I receives a command associated with a proximity position in a case where the user does not move and keeps at least one finger in proximity for more than a predetermined time period. The predetermined time is, for example, 2 seconds or more. Moreover, operations are not limited to the gesture operation, but another operation by which a receiver can receive a command associated with a position may be used.

Further, the embodiments described above explain the close range operation, the contact operation and the gesture operation. However, a combination of the close range operation and the gesture operation may be regarded as a user gesture. Moreover, a combination of the close range operation and the contact operation may be regarded as a user gesture. Furthermore, a combination of the contact operation and the gesture operation may be regarded as a user gesture. In addition, only the close range operation and the contact operation may be regarded as user gestures.

Further, the embodiments described above explain plural points located in proximity (plural-point proximity), taking two fingers next to each other of one hand of the user as an example. However, the plural-point proximity is not limited to the proximity of the two fingers next to each other of one hand of the user. For example, the plural-point proximity may be proximity of three fingers or more next to each other of one hand of the user or may be proximity of two fingers or more of different hands. In other words, any close range operation of the plural-point proximity may be possible where changed capacitance detected by a proximity detector is different from changed capacitance detected in a case of the one-point proximity, and where an obtaining part can obtain the proximity position of the plural points.

Further, the embodiments described above explain the configuration where the proximity detector detects the changed capacitance, using the self capacitive method and the contact detector detects the changed capacitance, using the mutual capacitive method. However, both of the proximity detector 10b and the contact detector 10a use the mutual capacitive method to detect the changed capacitance.

Further, the embodiments described above explain the configuration where the user moves a finger in proximity or touches with the user. However, an object including a user palm and a tablet pen may be used for the close range operation or the touch operation. In this case, based on a proximity state or a touch state of such an object, a position of the object may be deter pined as a position of the user.

Further, the embodiments described above explain, by taking a device used in a vehicle as an example of the display apparatus 1. However, the display apparatus 1 may be a smartphone, a tablet terminal, and other electronic apparatuses, devices, etc. that include a touch panel that is used to enter a character.

Further, in the embodiments described above, different functions are implemented by software by an arithmetic process performed by the CPU in accordance with a program. However, a part of the functions may be implemented by an electrical hardware circuit. Contrarily, in the embodiments described above, functions implemented by the hardware circuit may be implemented by software.

Further, according to the invention, the display apparatus discriminates between at least the two types of the close range operation before the close range operation is performed after the user proximity, and informs the user in different informing states depending on a discriminated result. Thus the user can understand whether or not the display apparatus 1 is ready to receive the operation after the user proximity.

Further, according to the invention, the display apparatus causes the light sources provided to the display apparatus, to emit light in different states, depending on whether the user proximity is the one-point proximity or the plural-point proximity to the display surface. Thus the user can understand whether or not the display apparatus 1 is ready to receive the close range operation corresponding to a user objective function.

Further, according to the invention, in the case of the plural-point proximity to the display surface by the user, the display apparatus causes the light sources to emit light having the first displayed color, and in the case of the one-point proximity to the display surface by the user, the display apparatus causes the light sources to emit light having the second displayed color. Thus the user can correctly understand a type of the close range operation that the display apparatus 1 is ready to receive, among the plural types of the close range operation performed to the touch panel.

Further, according to the invention, since the light sources are provided to near the display surface, the user can determine whether or not the display apparatus 1 is ready to receive the close range operation corresponding to the user objective function, seeing a displayed state of the display surface of the display 2.

Further, according to the invention, the display apparatus causes the light sources provided to the display apparatus, to emit light in the different states, depending on the user proximity is the one-point proximity or the plural-point proximity to the display surface of the touch panel or the operation portion area provided near the display surface. Thus the user can determine whether or not the display apparatus 1 is ready to receive the close range operation to execute the user objective function, among plural functions that can be executed by the close range operation.

While the invention has been shown and described in detail, the foregoing description is in all aspects illustrative and not restrictive. It is therefore understood that numerous other modifications and variations can be devised without departing from the scope of the invention.

What is claimed is:

1. A display apparatus that displays an image on a display, the display apparatus comprising:
a detector that detects (i) proximity of an object to the display and (ii) an operation that is performed by the object after detecting the proximity; and
a controller that discriminates between at least two types of the proximity of the object before the operation performed by the object after detecting the proximity, and that controls an informing part to provide different information, depending on a discriminated result.

2. The display apparatus according to claim 1, wherein
the at least two types of proximity include (a) proximity of one finger of an operator of the apparatus, and (b) proximity of more than one finger of the operator of the apparatus.

3. The display apparatus according to claim 2, wherein
the different information is a color that is emitted by a light source, and
when the proximity of more than one finger of the operator of the apparatus is detected, the light source emits light having a first color, and when the proximity of one finger of the operator of the apparatus is detected, the light source emits light having a second color different from the first color.

4. The display apparatus according to claim 3, wherein
the operation performed by the object that is detected after detecting the proximity includes detecting movement of the object in a direction substantially parallel to a surface of the display.

5. The display apparatus according to claim 1, wherein
the different information is a color that is emitted by a light source, and
when a first type of the proximity is detected, the light source emits light having a first color, and when a second type of the proximity is detected, the light source emits light having a second color different from the first color.

6. The display apparatus according to claim 1, wherein
the operation performed by the object that is detected after detecting the proximity includes detecting movement of the object in a direction substantially parallel to a surface of the display.

7. A display apparatus that displays an image on a display surface of a display, the display apparatus comprising:
a detector that detects user proximity to one or both of the display surface and an operation portion area provided near the display surface;
a light source; and
a controller that causes the light source to emit light in different states, depending on whether the user proximity is proximity with one point or with plural points, to one or both of the display surface and the operation portion area.

8. The display apparatus according to claim 7, wherein
the controller causes the light source to emit light
(i) in a first displayed color in a case where the user proximity is the proximity with the plural points to one or both of the display surface and the operation portion area; and
(ii) in a second displayed color, different from the first displayed color, in a case where the user proximity is the proximity with the one point, to one or both of the display surface and the operation portion area.

9. The display apparatus according to claim 7, wherein
the light source is provided near the display surface.

10. A displaying method for displaying an image on a display surface of a display, the displaying method comprising the steps of:
detecting user proximity to one or both of the display surface and an operation portion area provided near the display surface; and
causing a light source to emit light in different states depending on whether the user proximity is proximity with one point or with plural points, to one or both of the display surface and the operation portion area.

11. The displaying method according to claim 10, wherein
the light source is caused to emit light (i) in a first displayed color in a case where the user proximity is the proximity with the plural points to one or both of the display surface and the operation portion area; and (ii) in a second displayed color, different from the first displayed color, in a case where the user proximity is the proximity with the one point, to one or both of the display surface and the operation portion area.

12. The displaying method according to claim 10, wherein
the light source is provided near the display surface.
